(19) United States
(12) Patent Application Publication
(10) Pub. No.: US 2014/0065264 A1
(43) Pub. Date: Mar. 6, 2014

(54) NUTRITION FORMULATION AND PRODUCT PRODUCED THEREFROM

(71) Applicants: Paul Phuong Do, Markham (CA); Sherri-Ann Harrison, Whitby (CA)

(72) Inventors: Paul Phuong Do, Markham (CA); Sherri-Ann Harrison, Whitby (CA)

(21) Appl. No.: 14/071,533

(22) Filed: Nov. 4, 2013

Related U.S. Application Data
(63) Continuation-in-part of application No. PCT/CA2013/000440, filed on May 3, 2013.
(60) Provisional application No. 61/642,988, filed on May 4, 2012.

(51) Int. Cl. A23L 1/29

(52) U.S. Cl. CPC A23L 1/296
USPC 426/73; 426/599; 426/615; 426/616; 426/639; 426/548; 426/72; 426/74; 426/637; 426/558

(57) ABSTRACT

A nutritional composition is provided herein for optimizing fats, carbohydrates, and protein caloric ratios as it relates to balanced nutrition, general health, and muscle performance during exercise and for enhancing muscle cell repair and recovery following the cessation of exercise, comprising: a) about 18% to about 23% by weight, e.g. about 19% to about 21%, of whey protein, e.g. whey protein isolate; b) about 65% to about 70% by weight, e.g. about 67% to about 69%, of a “Superfruit and Vegetable Blend”, a concentrated fruit juice and a sweetener, such as honey; and c) about 10% to about 15% by weight, such as about 11% to about 13%, of a vegetable oil, e.g., olive oil, such as extra virgin olive oil, virgin olive oil, cold pressed olive oil.

### FIELD OF THE INVENTION

This invention relates to balanced nutrition and a 10 to 1 formulation and processes that result in various forms of nutrient dense food products, food-based vitamin and mineral supplementation, and in one preferred embodiment to a pre-workout and post-workout protein bar to provide balanced nutrition, general health and recovery. The present invention also relates to a nutritional composition for optimizing fats, carbohydrates, and protein caloric ratios for balanced nutrition and muscle performance during exercise, and for enhancing muscle cell repair and recovery following the cessation of exercise.

### BACKGROUND OF THE INVENTION

The popularity of nutritious foods has grown rapidly in recent years. Nutrition bars are convenient vehicles for snacks intended to boost energy, and the addition of new and/or trendy health based ingredients have changed the way the industry manufactures common household foods such as muffins and other healthy candy-type snacks.

For general health and recovery, it is important to understand the optimal ratio of caloric intake for daily consumption of foods. Ideally, caloric intake consists of a balanced diet and comes from quality fats, quality carbohydrates, and quality proteins.

Fats are needed to help absorb fat soluble vitamins and cushion the vital internal organs. Unsaturated fats (for example, chia seeds and avocados) are quality fats and should be consumed as much as possible. Research shows that consumption of monounsaturated and polyunsaturated fats can decrease the risk of breast cancer, reduce cholesterol levels, lower risk for heart disease and stroke, promote weight loss, yield less severe pain and stiffness for sufferers of rheumatoid arthritis, and reduce belly fat. Omega 3, 6, 9 essential fatty acids have numerous health benefits.

Omega 3 and 6 fatty acids cannot be produced in the body and must come from external food sources. Omega 3 and 6 fatty acids are converted into eicosapentaenoic acid (EPA) and docosahexaenoic acid (DHA) in the body, and are highly unsaturated fats that play a significant role in brain, eye, and skin health and vitality.

Carbohydrates are the main energy source for the body. Simple carbohydrates are derived from natural sugars in fruit and are a source for instant energy, while complex carbohydrates from vegetables provide fibre for sustained energy. Carbohydrates are very important in the maintenance of blood sugar levels. Glucose is converted in the liver to glycogen for storage. When needed the liver converts glycogen back into glucose and releases it into the blood stream at intervals to regulate blood sugar levels. Carbohydrates encourage growth of beneficial intestinal bacteria that are involved in the production of certain vitamins and the absorption of calcium and phosphorous. Carbohydrates are needed for quick energy to allow the available protein to be used for building and repairing tissue. If the quantity of carbohydrates consumed is insufficient to supply energy, the body starts to burn its own tissue to supply energy.

Carbohydrates are also needed for the proper use of fats. If lower levels of carbohydrates are consumed, then larger than normal amounts of fats are called upon to supply energy, the body cannot handle the process of breaking down excess fats and the fat does not burn completely. Abnormal amounts of breakdown products build in the blood and cause ketosis.

Proteins are made up of amino acids. The human body links these amino acid chains together in very long chains to create the protein that is required to complete a task which, most often, is for muscle repair (growth), nail and hair growth, and enzyme and hormone production and regulation in the body. Proteins containing all 22 amino acids are complete proteins from animal sources (including eggs, whey protein isolate).

There are 9 essential amino acids that are not manufactured by the body and need to be consumed from our foods. Quality proteins contain all 9 essential amino acids. The daily protein intake is proportioned to body weight; if too much protein is consumed it is either used as fuel as needed, or converted to fat. Fats are far more difficult for the body to break down; therefore a consistent build-up of protein in the human body over time does more harm than good and leads to ketosis. Failure to consume adequate amounts of protein will lead to the break down of muscle tissue. This causes loss of muscle mass, which is comprised of 20% protein, and triggers poor immune conditions.

Vitamins and minerals that occur naturally in foods are responsible for cell replenishment and play a role in the over 1 million essential chemical reactions the body completes daily. Vitamins (and some minerals) are either water soluble (Vitamins in the B group and Vitamin C, calcium, iron) or fat soluble (Vitamin A, Vitamin D, Vitamin E, Vitamin K).

Vitamins are assimilated in the body when taken with a delivery of vitamin absorbent food. Most fruits and vegetables are 95% water; on the other hand, chia seeds, coconut, or avocados contain highly mono and polyunsaturated fats and constitute optimum food delivery agents which can promote the absorption of vitamins and minerals in the human body.

Nutrient-dense foods provide balanced nutrition for general health and recovery. Additional food supplements for enhancing an athlete's muscle size and strength have become popular substitutes for steroids and other drugs in various sports and body building regimes. However, as athletes continually strive for improved performance, there is a continuing need for non-steroid containing aids for increasing lean mass, muscle size and strength.

Some meal replacement bars for use in conjunction with very low calorie formula diets have been proposed, but these generally do not meet objectives of supplying protein without an excess of carbohydrate. High protein/low carbohydrate baked or compressed products are known; however known bars made by a confectionery process have a poor taste and provide a substitute for one or more meals at a very low calorie dietary regimen, which is much less palatable than, for example, a liquid formula diet.

### OBJECTS OF THE INVENTION

Despite the many previous efforts to formulate muffins, bars, healthy candy type snack foods with proteins, and especially with whey proteins, there is still a need for a nutritious and nutrient dense food that appeals to the palate and contains optimum levels of whey protein. The prior art does not disclose optimum, practical nutritional formulations in various physical forms for general health, for the enhancement of endurance before exercise, and for the optimization of muscle recovery following exercise.

Thus, what is needed is portable food products that have improved nutritional characteristics for balanced nutrition and provide a taste that appeals to the palate.

Accordingly, it is an object of one aspect of the present invention to provide a nutritional formulation for enhancing general health, endurance before exercise, for optimizing muscle performance during exercise, and for enhancing muscle cell recovery following the cessation of exercise.

An object of another aspect of the present invention is to provide a nutritional formulation that is produced in such a manner as to start with a weight of raw ingredients in various forms and reduce the raw ingredients to one tenth of the starting weight through the manufacturing process, without losing any of the nutrients or micro-nutrients in the original raw ingredients. Ingredients that can enable such a high concentration of finished product, while retaining the nutritional properties mentioned above are:
Sweet Potato;
Avocado,
Banana;
Apple;
Orange;
Pomegranate;
Cranberry;
Blueberry;
Blackberry;
Dates;
Plus Egg Whites; and
Whey Protein Isolates.

This blend of fruits, vegetables and protein can be provided in multiple edible forms, such as: a “Smoothie”, as a liquid beverage, as a nutrition bar, healthy candy type snacks, as a baked product including muffins, cakes/loafs, cookies, brownies, and flat bread etc., as well as food vitamins, that is pleasant tasting, nutrient dense, and can be readily and conveniently available to the consumer.

### GENERALIZED DESCRIPTION OF THE INVENTION

An essential component of the present invention is to begin the manufacturing process with a starting weight of raw ingredients in various forms and through the manufacturing process, to produce a finished product having one tenth of the starting weight without losing any of the nutrients or micro-nutrients in the original raw ingredients, thus creating a blend of fruit, vegetables and protein, including a non-soy, non-hydrolyzed, non-instantized whey protein isolate.

As is generally well known, whey protein is a mixture of globular proteins isolated from whey, and consists of the liquid material created as a by-product of cheese production. Whey is left over when milk coagulates and contains everything that is soluble from milk. Whey is usually a 5% solution of lactose in water, and also contains a number of minerals, and lactalbumin. Whey is removed after cheese is processed. The fat is separated from the whey protein and the whey protein is then processed for human foods. Processing consists of varied processes of food treatment, and can range from simple drying, to facilitating the increase of the protein content through the removal of lipids and other non-protein materials. For example, spray drying after membrane filtration separates the proteins from whey.

Whey protein is the collection of globular proteins that are isolated from whey. Whey protein is typically a mixture of beta-lactoglobulin (approximately 65%), alpha-lactoglobulin (approximately 25%), and serum albumin (approximately 8%), which are soluble in their native forms, independent of pH. The protein fraction in whey (approximately 10% of the total dry solids within whey) comprises four major, proteins and six minor proteins. The major proteins in whey are, as noted above:
beta-lactoglobulin;
alpha-lactoglobulin;
bovine serum albumin; and
immunoglobulins.

Whey protein generally may generally be consumed provided in four major forms:
1) Concentrate: Concentrates typically have a low (but still significant) level of fat and cholesterol but have higher levels of bioactive compounds and carbohydrates in the form of lactose. They are about 29% to 89% protein by weight and are mild to slightly milky in taste.
2) Isolate: Isolates are processed to remove the fat and lactose present in the compound of origin but are usually lower in bio-activated compounds, similar to concentrates mentioned above. They are about 90% or more protein by weight, and are mild to slightly milky in taste. In aspects of the present invention, whey isolates are the preferred form of whey proteins for use;
3) Hydrolysate: Hydrolysates are whey proteins that are predigested and partially hydolyzed for the purpose of easier metabolizing.
4) Instantized: Instantized whey protein concentrate or instantized whey isolate includes “soy lecithin” that is bonded to the fruit, i.e. it is a mixture of whey protein less than 0.5% lactose from the whey.

### STATEMENTS OF INVENTION

A broad aspect of one aspect of the present invention provides a nutritional composition for optimizing fats, carbohydrates, and protein caloric ratios as it relates to balanced nutrition, general health, and muscle performance during exercise and for enhancing muscle cell repair and recovery following the cessation of exercise, comprising: a) about 18% to about 23% by weight, e.g. about 19 to about 21%, of whey protein, e.g. whey protein isolate;
b) about 65% to about 70% e.g., about 67% to about 69%, by weight of a the total of a superfruit blend, a concentrated fruit juice and a sweetener e.g., honey; and c) about 10% to about 15% e.g., about 11% to about 13% of a vegetable oil, e.g., olive oil, e,g, extra virgin olive oil; the balance being non-essential, optional or filler ingredients.

A broad aspect of another aspect of the present invention provides a nutritional composition for optimizing fats, carbohydrates, and protein caloric ratios as it relates to balanced nutrition, general health, and muscle performance during exercise and for enhancing muscle cell repair and recovery following the cessation of exercise, comprising:
a) about 34% to about 39% by weight, e.g. about 35% to about 37% of whey protein, e.g whey protein isolate; and egg whites.
b) about 40% to about 45% by weight, e.g., about 42% to about 44%, by weight of the total of a superfruit blend, sweet potato; and
c) about 10% to about 15% by weight e.g., of fats about 12% to about 14% of avocado, and chia seeds; and
d) about 7% to about 12% inclusions e.g., coconut, pumpkin seeds, baking soda and baking fruit as well as very minor amounts of such secondary ingredients as, milk less than 0.5% lactose from the whey; the balance being non-essential, optional or filler ingredients.

All other variants and variations of this invention are particularized in the claims which follow.

The foregoing summarizes the principal features of the invention and some of its optional aspects. The invention may be further understood by the description in the following examples

### EXAMPLES

### Example 1

### Pre Nutritious Formula Bar And Nutritious Formula Bar

The “Nutritious Formula Bar” is nutrient dense and contains 25 g of natural carbohydrates consisting of fruit, honey and fruit juice. It contains 5 g of omega 9 rich fat consisting of extra virgin olive oil, 10 g of organic isolated protein consisting of whey protein isolate, and 12 g of fruit blend with high nutrient content and antioxidant quality fruit. Fruit blend (also referred to herein as “superfruit blend”) consists of only fruit, for providing antioxidants and other nutrients.

The Nutritious Formula Bar also contains espresso from 100% Brazilian coffee beans, which provide physical energy and mental alertness without fatigue. The Nutritious Formula Bar provides essential calories allowing for the excessive burn of calories and fats and the inevitable muscle breakdown. The energy thus supplied enables boosting workout and optimizing performance.

The Nutritious Formula Bar is made with fruits, which provide fruit fibre and the essential carbohydrates required to stimulate insulin release. The carbohydrates and amino acids from protein thus provided enable the body to rebuild muscle and energy sources.

The Pre-Nutritious Formula Bar contains the following primary ingredients, namely, honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as very minor amounts of such secondary ingredients as milk, with less than 0.5% lactose from the whey.

The Nutritious Formula Bar contains the following primary ingredients, namely, honey, whey protein isolate, apple juice concentrate, extra virgin olive oil, banana fruit, apple fruit, cranberry fruit, blueberry fruit, blackberry fruit, pomegranate fruit, as well as very minor amounts of such secondary ingredients as milk, with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

The benefits of these primary ingredients may be summarized as follows:

Honey: Honey is carbohydrate-rich and provides a fuel source for all workout muscles.

Whey protein: Whey protein is a complete protein containing all 22 amino acids and all 9 essential amino acids in amounts proportional to the needs of the human body.

Extra virgin olive oil: Extra virgin olive oil controls levels of low density lipoproteins while increasing levels of high density lipoproteins. It contains a large amount of oleic acid.

Apple juice concentrate: Apple juice is rich in pectin and has a high content of the minerals potassium, calcium, phosphorus and magnesium as well as lesser amounts of the metals iron, manganese, copper, and zinc. It is a powerful anti-oxidant, and an anti-inflammatory and anti-histamine agent.

Coffee beans: Coffee contains the alleged anti-cancer compound methylpyridinium, which is formed during the roasting of the raw coffee beans.

Banana: Bananas are rich in potassium an electrolyte necessary for proper working of body cells. Potassium regulates the heartbeat and the function of the muscles.

Dark cocoa bean: Cocoa contains a large concentration of anti-oxidants.

Apple fruit: Apples contain a high concentration of soluble fibre that minimizes blood sugar swings.

Mango: Mangos contain a high concentration of vitamin C, which can strengthen the immune system of the human body.

Pineapple: Pineapples contain a high concentration of manganese, which is needed to build bone and connective tissue.

Blackberry: Blackberries are a source of lycopene and ellagic acid, which is alleged to prevent cell damage. Blackberries also contain Vitamin E.

Blueberry: Blueberries contain ellagic acid.

Cranberry: Cranberries maintain urinary tract health.

Pomegranate fruit: Pomegranates contain phytochemicals, lutein for good vision and Vitamin C.

Other minor secondary ingredients are ones that are used in the processing of the whey protein isolate, namely milk containing less than about 0.5% lactose

### Example 2

### Superfruit Protein Blend

The “ Superfruit Protein Blend” is an antioxidant rich organic and isolated protein blend that mixes easily with juice, water or any other liquid. The superfruit blend component supplies dietary fibre directly from fruit. The combination of natural carbohydrates, fruit and honey provide an insulin spike after exercise to stop muscle burning and to allow the protein better to be used for the synthesis of new muscle.

The “ Superfruit Protein Blend” contains the following primary ingredients, namely, whey protein isolate, blackberry fruit, cranberry fruit, banana fruit, blueberry fruit, apple fruit, pomegranate fruit, and honey; the following amino acids: alanine, arginine, aspartic acid, cysteine, glutamic acid, glycine, histidine, isoleucine, leucine, lysine, methionine, phenylalanine, proline, serine, threonine, tryptophan, tyrosine and valine; the following proteins: alpha-lactoglobulin, beta-lactoglobulin, glyco-macropeptides, bovine serum albumin, immunoglobulin G and protease peptone 5; as well as very minor amounts of such secondary ingredients as milk, with less than 0.5% lactose from the whey.

The broad range and optimum range of ingredients are:
Whey protein isolate; about 68% to about 72%; about 70% to about 71%; and total amounts of the other primary ingredients: about 25% to about 30%; about 27% to about 29%.

It is preferred, however, to add the whey isolate, the superfruit blend and the honey in the form of a 70% whey isolate and 25% superfruit blend and 5% solid honey granules, which are nuggets of pure solid honey without any artificial flavorings and natural or artificial sweeteners from the stevia family.

### EXAMPLE 3

### Espressoberry Nutritious Formula Bar

Espresso Berry Nutritious Formula Bar contains dark chocolate and espresso with a caffeine content that is equivalent to one cup of filtered coffee. This provides healthy energy without experiencing jitters or a dramatic change in blood sugar.

The Espressoberry “Nutritious Formula Bar” contains the following primary ingredients, namely, honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as very minor amounts of such secondary ingredients as milk, with less than 0.5% lactose from the whey.

Thus, the superfruit blend here is a mixture of banana, apple, mango, pineapple, blackberry, blueberry, cranberry, and pomegranate fruits.

The Espressoberry “Nutritious Formula Bar” is a nutrient dense composition containing 24 g of natural carbohydrates consisting of fruit, honey and fruit juice; 5 g of omega 9 rich fat consisting of extra virgin olive oil; 10 g of whey protein isolate; 8 g of superfruit blend consisting of exceptional nutrient richness and antioxidant quality fruit; and natural caffeine from coffee beans.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 4

### Smoothie Berry “Nutritious Formula Bar”

The Smoothie Berry “Nutritious Formula Bar” contains whey protein isolate in addition to various other ingredients, aiding in keeping a balanced sugar level in the human body. The Smoothie Berry “Nutritious Formula Bar” may be used before or after an exercise regime, in addition to serving as a regular food source.

The Smoothie Berry “Nutritious Formula Bar” is a nutrient dense composition containing 25 g of natural carbohydrates consisting of fruit, honey and fruit juice; 6 g of omega 9 rich fat consisting of extra virgin olive oil; 10 g of whey protein isolate; and 15 g of superfruit blend consisting of exceptional nutrient richness and antioxidant quality fruit.

Thus, the superfruit blend here is a mixture of banana, apple, blackberry, blueberry, cranberry, and pomegranate fruit.

The Smoothie Berry “Nutritious Formula Bar” contains the following primary ingredients, namely, honey, whey protein isolate, apple juice concentrate, extra virgin olive oil, banana fruit, apple fruit, cranberry fruit, blueberry fruit, blackberry fruit, pomegranate fruit, as well as very minor amounts of such secondary ingredients as milk, with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 5

### Protein Berry Nutritious Formula Healthy Candy

The PROTEIN BERRY Nutritious Formula Healthy Candy contains essential nutrients, and can have low amounts of fat, is low in sodium and contains sweeteners from the fruit, honey, and apple juice concentrate.

The PROTEIN BERRY Nutritious Formula Healthy Candy is a nutrient dense composition containing about 4 g of natural carbohydrates from fruit, honey and fruit juice; about 1 g of omega 9 rich fat consisting of extra virgin olive oil; about 2 g of whey protein isolate; and about 1 g of superfruit blend.

The ingredients of PROTEIN BERRY Nutritious Formula Healthy Candy are: honey; whey protein; apple juice concentrate; extra virgin olive oil; banana fruit; apple fruit; cranberry fruit; blueberry fruit; blackberry fruit; fruit pomegranate fruit; milk, with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 6

### Espresso Berry Nutritious Formula Healthy Candy

The ESPRESSO BERRY Nutritious Formula Healthy Candy contains dark cocoa and berry with natural espresso that is equivalent to ⅓ cup of coffee in caffeine content. providing a natural energy boost without a dramatic drop is sugar levels.

The ESPRESSO BERRY Nutritious Formula Healthy Candy is a nutrient dense composition and contains about 4 g of natural carbohydrates consisting of fruit, honey and fruit juice; about 1 g of omega 9 rich fat consisting of extra virgin olive oil; about 2 g of organic isolated protein consisting of whey protein isolate; and about 1 g of superfruit blend consisting of exceptional nutrient richness and antioxidant quality fruit.

The ingredients of ESPRESSO BERRY Nutritious Formula Healthy Candy are: honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as very minor amounts of such secondary ingredients as milk, with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 7

### Nutrient Dense Food Vitamins-Multi Vitamins and Minerals

NUTRIENT DENSE FOOD VITAMINS-MULTI VITAMIN AND MINERAL bar provides macronutrients that are rich in nutritional and nutrient value. Their ingredients are proteins (which provide tissue repair, immune system function, hormone and enzyme production for lean muscle mass and tone); carbohydrates, which are the primary energy source for the brain and are a source of calories to maintain body weight; and fats, which are considered the most energy-efficient form of food. Macronutrients are the transportation for the micronutrients and vitamins.

These nutrients are almost immediately absorbed and used by the body. The NUTRIENT DENSE FOOD VITAMINS-MULTI VITAMIN AND MINERAL bar is thus a good source of multi-vitamins.

The ingredients of the NUTRIENT DENSE FOOD VITAMINS-MULTI VITAMIN AND MINERAL bar are honey; whey protein; apple juice concentrate; extra virgin olive oil; banana fruit; apple fruit; blueberry fruit; cranberry fruit; blackberry fruit; pomegranate fruit; and milk; with less than 0.5% lactose from the whey.

In addition, the Nutrient Dense Food Vitamins-Multi Vitamin and Mineral Bar contains the following vitamins and minerals: Vitamin A, Vitamin D3, Vitamin E, Biotin, Folic Acid, Vitamin B5, Vitamin B1, Vitamin B12, Vitamin B2, Vitamin B6, Vitamin C, Calcium, Copper, Iodine, Iron, Magnesium, Zinc, Choline and Inositol.

The broad range and optimal range of ingredients are:
Whey protein isolate; about 11% to about 16%; about 12% to about 14%;
Extra virgin olive oil: about 12% to about 17%; about 13% to about 15%; and
Total amounts of the other primary ingredients: about 70% to about 75%; about 72% to about 74%.

The Nutrient Dense Food Vitamins-Multi Vitamin and Mineral” Bar is a nutrient dense composition and contains 5 g to 25 g of natural carbohydrates consisting of fruit, honey and fruit juice; 1 g to 6 g of omega 9 rich fat consisting of extra virgin olive oil; 1 g to 10 g of whey protein isolate; and 2 g to 15 g of superfruit blend consisting of a blend of fruits mentioned above.

### Example 8

### Nutrient Dense Food Vitamins-Vitamin D With Zinc And Seabuckthorn

NUTRIENT DENSE FOOD VITAMINS-VITAMIN D WITH ZINC AND SEA BUCKTHORN provide macronutrients that are high in nutritional and nutrient value. The ingredients are proteins, which provide tissue repair, immune system function, hormone and enzyme production for lean muscle mass and tone; carbohydrates, which provide a primary energy source for the brain and are a source of calories to maintain body weight; and fats, which are considered the most energy-efficient form of food). The macronutrients are the transportation for the micronutrients and vitamins. These nutrients are almost immediately absorbed and used by the body. The NUTRIENT DENSE FOOD VITAMINS-VITAMIN D WITH ZINC AND SEA BUCKTHORN is thus a good source of multi-vitamins.

Sea buckthorn contains more than 190 compounds in the seeds, pulp and juice. These compounds include Vitamins A, K, E, C, B1, and B2, 42 lipids, organic acids, amino acids, folic acid, tocopherols, flavenoids, phenols, terpenes and tannins Sea buckthorn also contains 20 mineral elements.

The ingredients of NUTRIENT DENSE FOOD VITAMINS-VITAMIN D WITH ZINC AND SEABUCKTHORN are: honey; whey protein; apple juice concentrate; extra virgin olive oil; banana fruit; apple fruit; mango fruit; blueberry fruit; cranberry fruit; pineapple fruit; blackberry fruit; pomegranate fruit; and milk, with less than 0.5% lactose from the whey.

In addition, the Nutrient Dense Food Vitamins-Vitamin D with Zinc and Seabuckthorn contains the following vitamins and minerals: Vitamin D3 and Zinc.

The broad range and optimum range of ingredients are:
Whey protein isolate; about 20% to about 25%; about 21% to about 23%;
Extra virgin olive oil: about 10% to about 15%; about 11% to about 13%; and
Total amounts of the other primary ingredients: about 60% to about 65%; about 62% to about 64%.

“Nutrient Dense Food Vitamins-Vitamin D with Zinc and Seabuckthorn” is a nutrient dense composition and contains 4 g to 25 g of natural carbohydrates consisting of fruit, honey and fruit juice; 1 g to 6 g of omega 9 rich fat consisting of extra virgin olive oil; 2 g to 10 g of whey protein isolate; and 2 g to 15 g of superfruit blend consisting of exceptional nutrient richness and antioxidant quality fruit.

### Example 9

### Nutrient Dense Food Vitamins-Calcium And Magnesium With Vitamin D

NUTRIENT DENSE FOOD VITAMINS-CALCIUM AND MAGNESIUM WITH VITAMIN D provide macronutrients that are high in nutritional and nutrient value. The ingredients are proteins, which provide tissue repair, immune system function, hormone and enzyme production for lean muscle mass and tone; carbohydrates, which provide primary energy source for the brain and are a source of calories to maintain body weight; fats, which are considered the most energy-efficient form of food. The macronutrients are the mode of transportation for the micronutrients and vitamins. These nutrients are almost immediately absorbed and used by the body. It also is a good source of multi-vitamins.

Calcium is the most abundant mineral in the body and is essential for the formation and repair of bone and teeth and other metabolic activities as well. Magnesium is a mineral necessary for energy metabolism, aids in bone growth and binding of calcium to teeth, etc. Both minerals require each other for their absorption and maximum utilization and Vitamin D aids in the direct absorption of calcium.

The ingredients of NUTRIENT DENSE FOOD VITAMINS-CALCIUM AND MAGNESIUM WITH VITAMIN D are: honey; whey protein; apple juice concentrate; extra virgin olive oil; banana fruit; apple fruit; blueberry fruit; cranberry fruit; blackberry fruit; pomegranate fruit; and milk; with less than 0.5% lactose from the whey.

In addition NUTRIENT DENSE FOOD VITAMINS-CALCIUM AND MAGNESIUM WITH VITAMIN D contain the following vitamin and minerals: namely Vitamin D3, Calcium, and Magnesium.

The broad range and optimum range of ingredients are:
Whey protein isolate; about 11% to about 16%; about 12% to about 14%;
Extra virgin olive oil: about 12% to about 17%; about 13% to about 15%; and
Total amounts of the other primary ingredients: about 70% to about 75%; about 72% to about 74%.

NUTRIENT DENSE FOOD VITAMINS-CALCIUM AND MAGNESIUM WITH VITAMIN D is nutrient dense and contains 5 g to 25 g of natural carbohydrates consisting of fruit, honey and fruit juice; 1 g to 6 g of omega 9 rich fat consisting of extra virgin olive oil; 1 g to 10 g of organic isolated protein consisting of whey protein isolate; and 2 g to 15 g of superfruit blend consisting of exceptional nutrient richness and antioxidant quality fruit.

The broad range and optimum range of non-essential, optional or filler ingredients for the “Nutritious Formula Bar” and Nutritious Formula Healthy Candy are about 2 to about 8%; about 3 to about 6%.

The flavourings consist of the following: non-essential, optional or filler ingredients which are either pure alcoholic extracts, or spray dried natural, GMO free, and Kosher fruits of one or more of the following: pure allspice (pimento) extract, pure almond extract, amaretto natural flavor blend, pure anise extract, apple natural flavor blend, apricot natural flavor blend, banana natural flavor blend, pure basil extract, pure bergamot extract, blackberry natural flavor blend, blueberry natural flavor blend, bourbon extract natural flavor blend, brandy extract natural flavor blend, bubble gum natural flavor blend, butter natural flavor blend, butter rum natural flavor blend, butter scotch natural flavor blend, cappuccino natural flavor blend, caramel natural flavor blend, pure cardamom extract, Caribbean spice extract, Chia natural extract, Champagne extract natural flavor blend, cherry natural flavor blend, chocolate natural flavor blend, white chocolate natural flavor blend, pure cinnamon extract, pure clove extract, coconut natural flavor blend, robust coffee flavor, cranberry natural flavor blend, creme de menthe natural flavor blend, black currant (cassis natural flavor blend, pure “fiori di Sicilia” extract, sauteed natural garlic flavor, Grand Marnier natural flavor blend, Concord grape natural flavor blend, Highlander Grog natural flavor blend, Irish Cream natural flavor blend, pure jasmine extract, pure lavender extract, pure lemon extrct, pure key lime extract, pure Mandarin orange natural flavor blend, maple natural flavor blend, pure mint extract, Mocha natural flavor blend, sauteed onion natural flavor blend, pure orange extract, pure orange blossom extract, pure osmanthus extract, Passion fruit natural flavor blend, peach natural flavor blend, pear natural flavor blend, pure pomegranate extract, Pina Colada natural flavor blend, pineapple natural flavor blend, pistachio natural flavor blend, pomegranate natural flavor blend, Pound cake natural flavor blend, pumpkin pie natural flavor blend, raspberry natural flavor blend, pure red pepper extract, red velvet natural flavor blend, pure rose extract, rose water, rum flavor, pure spearmint extract, strawberry natural flavor blend, pure tangerine extract, natural black tea flavor, natural green tea flavor, English toffee natural flavor blend, black walnut natural flavor blend, watermelon natural flavor blend, and pure wintergreen extract.

### Example 10

### Nutrient Dense Muffins

The NUTRIENT DENSE MUFFINS ingredients are sweet potatoes, which are anti-oxidants and, anti-inflammatory and anti-arthritic agents, and are alleged to prevent stomach ulcers, lymphysema and can aid in digestion; avocado, which provides oleic acid, and is alleged to lower cholesterol; dates, which provide sweet dietary fibre, chia seeds, which provide omega-3 and antioxidants; unsweetened shredded coconut; pumpkin seeds and egg whites, which provide 22 amino acids to help build and repair cells.

The NUTRIENT DENSE MUFFINS contain 7 g of protein from whey protein isolate and 3 g of fibre.

The NUTRIENT DENSE MUFFINS contain the following primary ingredients, namely, Sweet Potato, Egg Whites, Avocado, Dates, Whey Protein Isolate, BlackBerry fruit, CranBerry fruit, Banana fruit, BlueBerry fruit, Apple fruit, Pomegranate fruit, Orange fruit, Raspberry fruit, Mango fruit, Dark Cocoa Beans, Chia Seeds, Coconut, Pumpkin Seeds, Natural Flavour, Unsweetened Dark Chocolate, Baking Soda, Baking Powder as well as very minor amounts of such secondary ingredients as milk with less than 0.5% lactose from the whey.

### The Benefit of Ingredients In the NUTRIENT DENSE MUFFINS

Sweet potatoes: Sweet potatoes are a source of antioxidants (Vitamins A and C); a source of anti-inflammatory compounds (Vitamins C and B6, beta-carotene, and manganese to help maintain collagen and reduce the risk of developing certain forms of arthritis and to soothe pain and inflammation of ulcers); carotenes (to assist in responding to insulin and stabilize blood sugar); high content of soluble fibre aids in lowering blood sugar and cholesterol); chlorogenic acid (to decrease insulin resistance); B vitamins, vitamin C, potassium, beta-carotene and calcium (help in healing of stomach ulcers); and fibre (helps prevent constipation and acidity).

Egg Whites: Egg whites have proteins which are almost immediately absorbed into the body. They are an excellent source of energy allowing the burning of fat while building muscle. They are low in calories.

Date Fruit: Date fruit contains several nutrients including calcium, fibre, amino acids, sulfur, iron, manganese, magnesium, phosphorus, copper and potassium as well as fats, dietary fibre and Vitamins A1, B1, B2, B3 and B5.

Avocados: Avocados contain such nutrients as Vitamin K, dietary fibre, potassium, Vitamin B6, Vitamin C and Copper. They contain oleic acid a monounsaturated fat that may help power cholesterol.

Unsweetened coconut: Coconut is rich in lauric acid, which is known to be anti-viral, anti-bacterial and anti-fungal while boosting the immune system.

Chia seeds: Chia seeds contain a high value of omega-3 fatty acids, which can keep blood pressure low and blood sugar under control.

Pumpkin seeds: Pumpkin seeds are a good source of phosphorus, magnesium, manganese, zinc, iron, and copper. They contain Vitamin K and proteins, L-tryptophan, which is a naturally effective protection against osteoporosis, and are effective in reducing inflammation without the side effects of anti-inflammatory drugs.

The broad range and optimum range of ingredients for the NUTRIENT DENSE MUFFINS are:
Protein: whey protein isolate +egg whites: about 34% to about 39%; about 35% to about 37%;
Carbohydrates: fruit and vegetable blend, i.e., banana, apple, blackberry, blueberry, cranberry, pomegranate, fresh sweet potatoes: about 40% to about 45%: about 42% to about 44%
Fat: fresh avocado and chia seeds: about 10% to about 15%; about 12% to about 14%.
Non-essential, optional or filler ingredients: pumpkin seeds and/or coconut and/or cinnamon and/or dates: about 7% to about 12%; about 8% to about 10%.

The non-essential, optional or filler ingredients are GMO free and Kosher for the NUTRIENT DENSE MUFFINS, include nuts, including almond, brazil nut, cashew, coconut, filbert, pecan, hazelnut, macadamia, and walnut; seeds including pumpkin, watermelon, sunflower, flax, chai, squash, pomegranate, grape, poppy and sesame; as well as, dates, figs, apricots, raisins, cranberries, mango, pineapple, carrot, zucchini, apple, banana, blueberries, blackberries, strawberries, raspberries, cherries, passion fruit, star fruit, pomegranate, citrus rind, and cinnamon, nutmeg, pumpkin spice, all spice, and black pepper.

### Preparations

A method to prepare the “Nutritious Formula Bar” & Nutritious Formula Healthy Candy is as follows:

Honey is heated in a kettle to 80 degrees Celsius, and all component liquids are mixed together thoroughly. All dry materials are then added to the liquid mixture and placed in a blender for thirty minutes. The mixture is then extruded onto a sheet, and pieces are cut to size. A dusting technique using a static sprayer is applied. The pieces are packaged.

A method to prepare the “Smoothie” Blend is as follows: The constituent dry ingredients are mixed together and blended for ten minutes and packaged.

A method to prepare Nutrient Dense Muffins: A combination of egg whites, sweet potato and avocado is mixed thoroughly, and whey protein, superfruit blend and chia seed are added to the mixture. Baking soda and baking powder are added to the mixture, after which is it baked for 20 to 22 minutes. The muffins are cooled for about 2 hours and packaged.

1. The foregoing has constituted a description of specific embodiments showing how the invention may be applied and put into use. These embodiments are only intended to be exemplary. The invention in its broadest and more specific aspects is further described and defined in the claims that follow.

These claims and the language used therein are to be understood in terms of the variants of the invention that has been described. They are not to be restricted to such variants, but are to be read as covering the full scope of the invention as is implicit within the invention and the disclosure that has been provided herein.

What is claimed is:

1. A nutritional composition for optimizing fats, carbohydrates, and protein caloric ratios as it relates to balanced nutrition, general health, and muscle performance during exercise, and for enhancing muscle cell repair and recovery following the cessation of exercise, the composition comprising:
a) about 18% to about 23% or about 19% to about 21% by weight, of a protein source;
b) about 65% to about 70% or about 67% to about 69% by weight, of a superfruit blend, a fruit juice concentrate and one or more sweeteners; and
c) about 10% to about 15% or about 11% to about 13% by weight, of one or more vegetable oils.

2. The nutritional composition as claimed in claim 1, wherein the protein source comprises select whey isolate, the sweetener comprises honey granules, wherein the honey granules are pure solid honey without any artificial flavorings, artificial sweeteners or stevia; and wherein the superfruit blend, concentrated fruit juice and sweetener together comprise 70% by weight, the superfruit blend comprises 25% by weight, and the sweetener comprises 5% by weight.

3. The nutritional composition of claim 1, wherein the superfruit blend comprises one or more of banana, apple, blackberry, blueberry, cranberry, pomegranate, mango, pineapple, watermelon, quince, kiwi, gooseberry, loganberry, peach, persimmon, rhubarb, cherry, papaya, strawberry, elderberry, grape, plum, raspberry, huckleberry, pear, Saskatoon berry, fig, lime, orange, cloudberry, canteloupe, honeydew, muskmelon, apricot, black currant, red currant, grapefruit, acai, sea buckthorn, and boysenberry.

4. The nutritional composition as claimed in claim 1, wherein the vegetable oil comprises extra virgin olive oil, coconut oil, corn oil, cottonseed oil, palm oil, peanut oil, canola oil, safflower oil, sesame oil, sunflower oil, almond oil, beech nut oil, cashew oil, hazelnut oil, pecan oil, pine nut oil, pistachio oil, walnut oil, grape seed oil, pumpkin seed oil or watermelon seed oil or any combination of the foregoing.

5. The nutritional composition as claimed in claim 1 wherein the fruit juice concentrate comprises juice of banana, apple, blackberry, blueberry, cranberry, pomegranate, mango, pineapple, watermelon, quince, kiwi, gooseberry, loganberry, peach, persimmon, rhubarb, cherry, papaya, strawberry, elderberry, grape, plum, raspberry, huckleberry, pear, Saskatoon berry, fig, lime, orange, cloudberry, canteloupe, honeydew, muskmelon, apricot, black currant, red currant, grapefruit, acai, sea buckthorn, or boysenberry, or any combination of the foregoing.

6. The nutritional composition of claim 1, wherein the sweetener is selected from the group consisting of: honey, maple syrup, corn syrup, stevia, brown rice syrup, agave sugar, evaporated cane juice, maltodextrose, sucralose, invert corn sugar, corn syrup, dextrose, unconverted dextrines, glucose, levulose, maltose, and any combination of the foregoing.

7. The nutritional composition as claimed in claim 1, further comprising one or more of the following: pure allspice (pimento) extract, pure almond extract, amaretto natural flavor blend, pure anise extract, apple natural flavor blend, apricot natural flavor blend, banana natural flavor blend, pure basil extract, pure bergamot extract, blackberry natural flavor blend, blueberry natural flavor blend, bourbon extract natural flavor blend, brandy extract natural flavor blend, bubble gum natural flavor blend, butter natural flavor blend, butter rum natural flavor blend, butter scotch natural flavor blend, cappuccino natural flavor blend, caramel natural flavor blend, pure cardamom extract, Caribbean spice extract, chia natural extract, Champagne extract natural flavor blend, cherry natural flavor blend, chocolate natural flavor blend, white chocolate natural flavor blend, pure cinnamon extract, pure clove extract, coconut natural flavor blend, robust coffee flavor, cranberry natural flavor blend, creme de menthe natural flavor blend, blackcurrant natural flavor blend, pure flori di Sicilia extract, sauteed natural garlic flavor, Grand Marnier natural flavor blend, Concord grape natural flavor blend, Highlander Grog natural flavor blend, Irish cream natural flavor blend, pure jasmine extract, pure lavender extract, pure lemon extract, pure key lime extract, pure Mandarin orange natural flavor blend, maple natural flavor blend, pure mint extract, mocha natural flavor blend, sauteed onion natural flavor blend, pure orange extract, pure orange blossom extract, pure osmanthus extract, passion fruit natural flavor blend, peach natural flavor blend, pear natural flavor blend, pure pomegranate extract, piña colada natural flavor blend, pineapple natural flavor blend, pistachio natural flavor blend, pomegranate natural flavor blend, pound cake natural flavor blend, pumpkin pie natural flavor blend, raspberry natural flavor blend, pure red pepper extract, red velvet natural flavor blend, pure rose extract, rose water, rum flavor, pure spearmint extract, strawberry natural flavor blend, pure tangerine extract, natural black tea flavor, natural green tea flavor, English toffee natural flavor blend, black walnut natural flavor blend, watermelon natural flavor blend and pure wintergreen extract, wherein the pure extracts and natural flavour blends are Kosher and free of material from genetically modified organisms.

8. The nutritional composition of claim 1 comprising: select whey protein isolate having a range of content by weight of about 18% to about 23% or about 19% to about 21%; extra virgin olive oil having a range of content by weight of about 10% to about 15% or about 11% to about 13%; and superfruit blend, apple juice concentrate and honey together comprising by weight about 65% to about 70% or about 67% to about 69%, wherein the superfruit blend comprises one or more of coffee, banana, apple, cocoa, select mango, select pineapple, select blackberry, select blueberry, select cranberry, and select pomegranate; and wherein the nutritional composition comprises less than 0.5% by weight of lactose.

9. The nutritional composition of claim 1 comprising: select whey protein isolate having a range of content by weight of about 18% to about 23% or about 19% to about 21%; extra virgin olive oil having a range of content by weight of about 10% to about 15% or about 11% to about 13%; and superfruit blend, apple juice concentrate and honey together comprising by weight about 65% to about 70% or about 67% to about 69%, wherein the superfruit blend comprises one or more of banana, apple, select blackberry, select blueberry, select cranberry, and select pomegranate; and wherein the nutritional composition comprises less than 0.5% by weight of lactose.

10. A nutritional composition comprising: select whey protein isolate having a range of content by weight of about 68% to about 72% or about 70% to about 71%; and superfruit blend, fruit juice concentrate, honey, and vegetable oil together comprising about 68% to about 72% or about 70% to about 71% by weight, wherein the superfruit blend comprises one or more of blackberry, cranberry, banana, blueberry, apple and pomegranate; and further comprising one or more of alanine, arginine, aspartic acid, cysteine, glutamic acid, glycine, histidine, isoleucine, leucine, lysine, methionine, phenylalanine, proline, serine, threonine, tryptophan, tyrosine and valine; and further comprising one or more of alpha-lactoglobulin, beta-lactoglobulin, glyco-macropeptides, bovine serum albumin, immunoglobulin G and protease peptone 5; and wherein the nutritional composition comprises less than 0.5% by weight of lactose.

11. A nutritional composition comprising: select whey protein isolate having a range of content by weight of about 11% to about 16% or about 12% to about 14%; extra virgin olive oil having a range of content by weight of about 12% to about 17% or about 13% to about 15%; and superfruit blend, apple juice concentrate and honey together comprising about 70% to about 75% or about 72% to about 74% by weight, wherein the superfruit blend comprises one or more of banana, apple, blueberry, cranberry, blackberry, pomegranate; and further comprising one or more of vitamin A, vitamin D₃, vitamin E, biotin, folic acid, vitamin B₅, vitamin B₁, vitamin B₁₂, vitamin B₂, vitamin B₆, vitamin C, calcium, copper, iodine, iron, magnesium, zinc, choline and inositol.

12. The nutritional composition of claim 1, wherein the sweetener comprises honey, the fruit juice concentrate comprises apple juice concentrate, the vegetable oil comprises extra virgin olive oil, and the protein source comprises select whey protein isolate, and wherein the composition further comprises one or more of banana, apple, blueberry, cranberry, blackberry, pomegranate, vitamin A, vitamin B₁₂, vitamin B₂, vitamin B₆, vitamin D₃, vitamin E, vitamin C, biotin, folic acid, pantothenic acid, calcium, copper, iodine, iron, magnesium, manganese, molybdenum, selenium, zinc, choline, inositol and natural flavors.

13. A nutritional composition comprising select whey protein isolate having a range of content by weight of about 20% to about 25% or about 21% to about 23%; extra virgin olive oil having a range of content by weight of about 10% to about 15% or about 11% to about 13%; and superfruit blend, apple juice concentrate and honey together comprising about 60% to about 65% or about 62% to about 64% by weight, wherein the superfruit blend comprises one or more of banana, apple, mango, blueberry, cranberry, pineapple, blackberry, pomegranate; the composition further comprising one or more of vitamin D₃, zinc, sea buckthorn, and less than 0.5% lactose by weight from the whey protein isolate.

14. A nutritional composition comprising select whey protein isolate having a range of content by weight of about 11% to about 16% or about 12% to about 14%; and extra virgin olive oil having a range of content of about 12% to about 17% or about 13% to about 15%; and
honey, apple juice concentrate, and superfruit blend together comprising about 70% to about 75% or about 72% to about 74% by weight, wherein the superfruit blend comprises one or more of banana, apple, blueberry, cranberry, blackberry, and pomegranate; and further comprises calcium, magnesium, and vitamin D₃.

15. The nutritional composition of claim 1 wherein the composition is in a form selected from the group consisting of: a liquid drink form, an energy bar, a protein bar, a candy, a cereal bar, a gelatin, a superfruit blend, and a frozen treat.

16. A nutritional composition for optimizing fats, carbohydrates, and protein caloric ratios as it relates to balanced nutrition, general health, and muscle performance during exercise, and for enhancing muscle cell repair and recovery following the cessation of exercise, the composition comprising a protein component having a range of content by weight of about 34% to about 39% or about 35% to about 37%, the protein component comprising egg whites and select whey protein isolate, wherein the whey protein isolate provides less than 0.5% lactose by weight; a carbohydrate component having a range of content by weight of about 40% to about 45% or about 42% to about 44%, the carbohydrate component comprising one or more of sweet potato, banana, apple, blackberry, blueberry, cranberry, pomegranate; a fat component having a range of content by weight of about 10% to about 15% or about 12% to about 14%, the fat component comprising one or more of chia seeds and avocado; the composition further comprising one or more of natural flavour, baking soda, pumpkin seeds, coconut, cinnamon and dates, together having a range of content of about 7% to about 12% or about 8% to about 10%.

17. The nutritional composition of claim 16, further comprising one or more of almond, Brazil nut, cashew, coconut, filbert, pecan, hazelnut, macadamia nut, walnut, pumpkin seed, watermelon seed, sunflower seed, flax seed, chai seed, squash seed, pomegranate seed, grape seed, poppy seed, sesame seed, dates, figs, apricots, raisins, cranberries, mango, pineapple, carrot, zucchini, apple, banana, blueberries, blackberries, strawberries, raspberries, cherries, passion fruit, star fruit, pomegranate, citrus rind, cinnamon, nutmeg, pumpkin spice, all spice, and black pepper.

18. The nutritional composition of claim 16 in a form selected from the group consisting of: a muffin, a cake, a loaf, a cookie, a brownie and a flat bread.
